(19) United States
(12) Patent Application Publication
(10) Pub. No.: US 2010/0181758 A1
(43) Pub. Date: Jul. 22, 2010

(54) Connector

(75) Inventor: Po-Wen Chen, Guantian Hsiang (TW)

Correspondence Address: CHARLES E. BAXLEY, ESQUIRE, 90 JOHN STREET, SUITE 309, NEW YORK, NY, 10038, US

(73) Assignee: Bueno Technology Co., Ltd.

(21) Appl. No.: 12/655,925

(22) Filed: Jan. 11, 2010

(30) Foreign Application Priority Data
Jan. 16, 2009 (TW) 098101517

(51) Int. Cl. F16L 33/00

(52) U.S. Cl. 285/245

(57) ABSTRACT

The connector has a body, detent ring and a nut. The body has a threaded portion that has a proximal end. The detent ring is mounted around the body and has a ring body. The ring body has an outer surface and at least one resilient detent member attached to the outer surface of the ring body. The nut is tightened on the threaded portion of the body and has an end and multiple bars attached to the end of the nut and engaging the at least one detent member. The connector informs users of a tightening level and prevents damage due to over-tightening.

### BACKGROUND OF THE INVENTION

1. Field of the Invention

The present invention relates to a connector, especially to a connector informing users of a tightening level and preventing damage due to over-tightening.

2. Description of the Prior Art

Hazardous liquid pipes are commonly used in the semiconductor industry and the pharmaceutical industry. Connectors used to connect the pipes together or to a device are required to have a reliable sealing function for preventing possible leakage, especially a leakage that frequently occurs at an insecurely sealed tightening portion.

A traditional connector has a body, a nut and a ring. The body has two ends, a through hole, a tightening portion, a holding portion, a threaded portion and a connecting portion, wherein the tightening portion, the holding portion, the threaded portion and the connecting portion are sequentially disposed along the body. The nut has an inner thread and a nut-holding portion. The ring is mounted between the body and the nut. The tightening member is used for connecting the traditional connector to a device. The connecting portion is used for connecting to a pipe.

However, when using the traditional connector, in order to achieve a sealing level considered to be reliable, the connector tends to be over tightened so deforming the body and the nut and breaking the body of the connector. With reference to FIG. 6, a conventional connector, such as one that described in Taiwan patent No. 108210, is used for preventing over-tightening. The conventional connector has a body (94) and a nut (90). The body (94) has a holding portion and a ring (92). The holding portion has one end. The nut (90) has one end and multiple first protrusions (91). The multiple first protrusions (91) are formed at the end of the nut (90) near the holding portion. The ring (92) is formed at the end of the holding portion of the body and has at least one second protrusion (93). When tightening the conventional connector, the multiple first protrusions (91) axially approach the ring (92). When the first protrusions (91) contact and engage the second protrusions (92), the second protrusion (93) will deform. When the first protrusions (91), which also move circumferentially, pass the second protrusion (93), the second protrusion (93) recovers its original shape and produces a ticking sound to indicate the connector is tightened sufficiently.

However, the conventional connector has the following problems.

With reference to FIG. 7, when tightening the conventional connector, the first protrusions (91) axially push and deform the second protrusion (93). Continuous pressing of the first protrusions (91) fatigues the second protrusion (93) and decreases the elasticity thereof.

When the connector is loosed and later used again, the less elastic second protrusion (93) will fail to perform expected deformation and accordingly fail to produce an informing ticking sound. Thus after much deformation, the connector fails to indicate the connector is tightened sufficiently.

Furthermore, if a user ignores the ticking sound and keep on tightening the connector to an over-tight extent, the first protrusions (91) will eventually go into and destroy a deforming chamber that connects the second protrusion (93) and the ring (92).

To overcome the shortcomings, the present invention provides a connector to mitigate or obviate the aforementioned problems.

### SUMMARY OF THE INVENTION

The main objective of the invention is to provide a connector informing users of a tightening level and preventing the damage due to over-tightening.

The connector in accordance with the present invention has a body, detent ring and a nut. The body has a threaded portion that has a proximal end. The detent ring is mounted around the body and has a ring body. The ring body has an outer surface and at least one resilient detent member attached to the outer surface of the ring body. The nut is tightened to the threaded portion of the body and has an end and multiple bars attached to the end of the nut and engaging the at least one detent member.

Other objectives, advantages and novel features of the invention will become more apparent from the following detailed description when taken in conjunction with the accompanying drawings.

### BRIEF DESCRIPTION OF THE DRAWINGS

FIG. 1 is an operational exploded perspective view of a connector in accordance with the present invention;

FIG. 2 is a cross sectional side view of the connector in FIG. 1;

FIG. 3 is an end view in partial section of the connector in FIG. 2 along the line 3-3 thereof;

FIG. 4 is an enlarged end view in partial section of the connector in FIG. 3, wherein the detent ring is in its original shape;

FIG. 5 is an enlarged end view in partial section of the connector in FIG. 3, wherein the detent ring is pushed to a deforming shape;

FIG. 6 is a side view in partial section of a conventional connector in accordance with the prior art, wherein the second protrusion is in its original shape; and

FIG. 7 is a side view in partial section of the conventional connector in

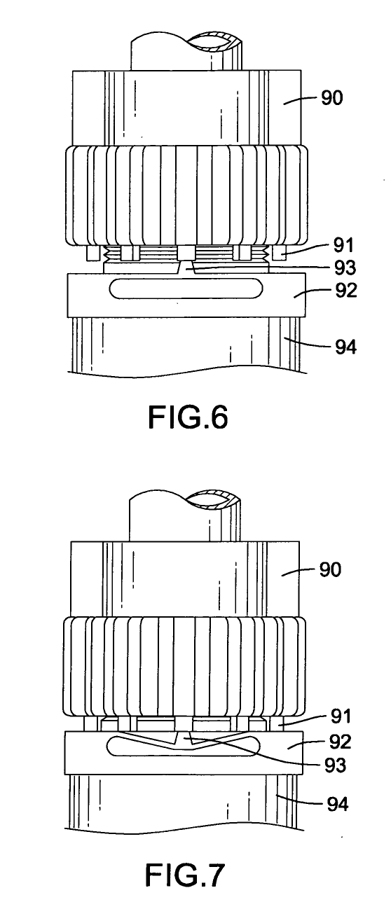

FIG. 6, wherein the second protrusion is pushed to a deforming shape.

### DETAILED DESCRIPTION OF THE PREFERRED EMBODIMENTS

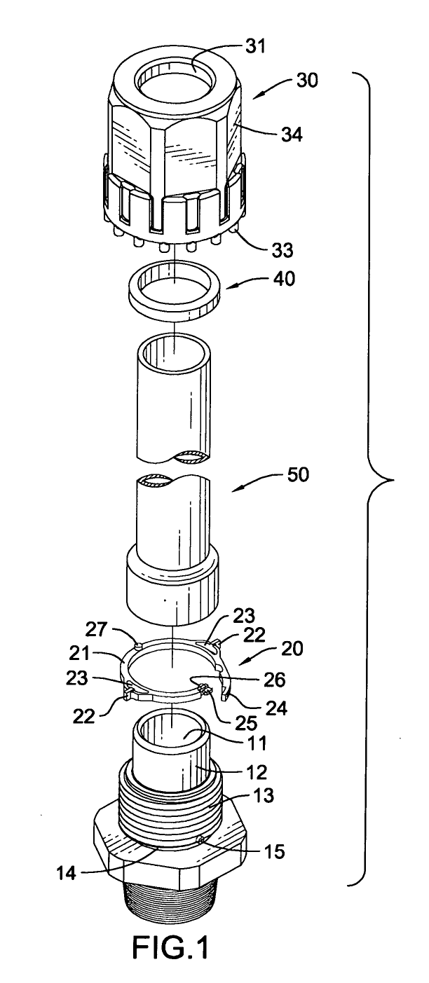

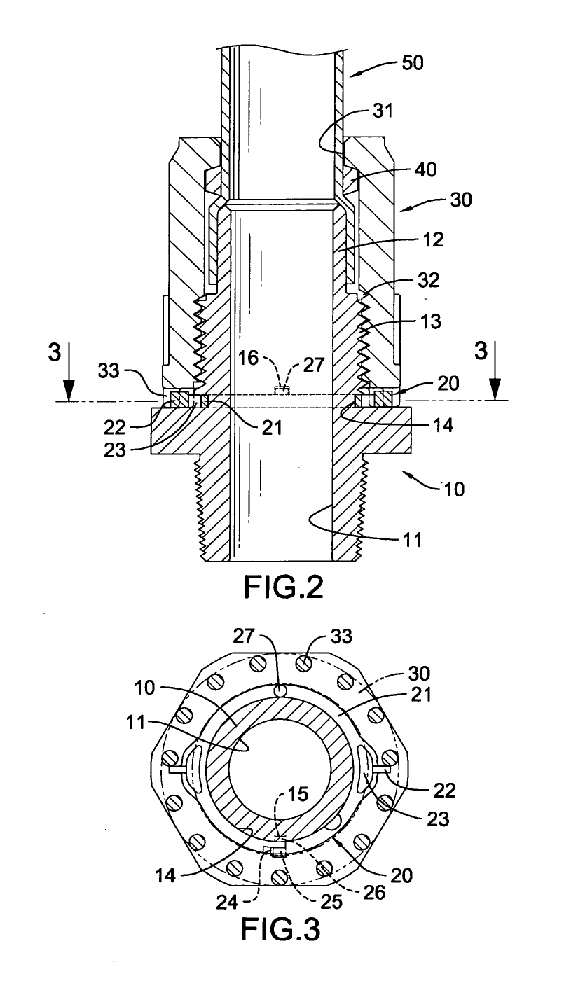

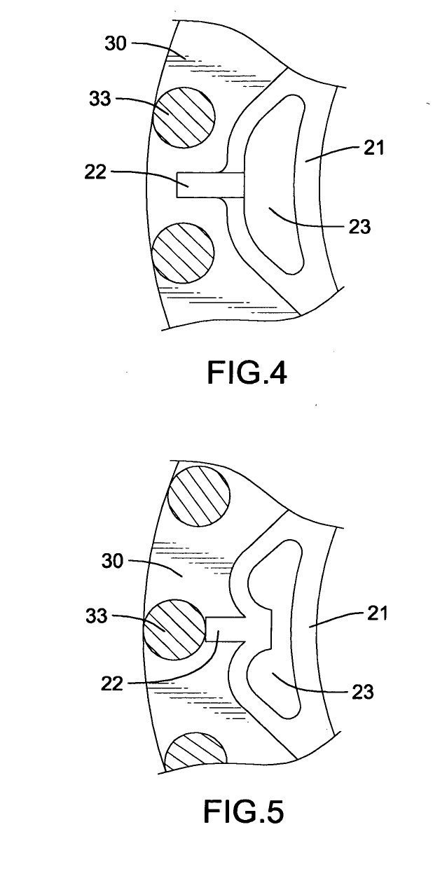

With reference to FIGS. 1 and 2, a connector in accordance with the present invention comprises a body (10), detent ring (20), a nut (30) and an optional annular ring (40).

The body (10) comprises two ends, a through hole (11), a connecting portion (12), and a threaded portion (13) and an annular groove (14). The connecting portion (12), the threaded portion (13) and the annular groove (14) locate in order from end to another end of the body (10). The connecting portion (12) is for connecting a pipe (50). The threaded portion (13) is formed on the body (10) and comprises a proximal end. The annular groove (14) is defined in the body (10) and comprises a bottom, a wall, and two positioning members (15, 16) respectively formed on the bottom and the wall of the annular groove (14). The two positioning members (15, 16) may be recesses.

The detent ring (20) is mounted around the body (10) and comprises a ring body (21). The ring body (21) comprises an outer surface, at least one resilient detent member (22) and an optional recoil chamber (23). The resilient detent member (22) is attached to the outer surface of the ring body (21). The recoil chamber (23) is formed between the ring body (21) of the detent ring (20) and the detent member (22). The recoil chamber (23) may be a hole.

The ring body (21) of the detent ring (20) further comprises a first fastener (24) and a second fastener (25). The first fastener (24) is formed on the ring body (21). The second fastener (25) is formed on the ring body (21) for connecting to the first fastener (24). The ring body (20) may be mounted around to the annular groove (14) of the body (10) by connecting the first fastener (24) and the second fastener (25). Furthermore, the detent ring (20) further comprises two positioning elements (26, 27) corresponding to the foregoing positioning members (15, 16). The positioning elements (26, 27) are respectively inserted in the positioning members (15, 16) to fasten the detent ring (20) to the body (10).

With reference to FIG. 3, the nut (30) is tightened to the threaded portion (13) of the body (10) and comprises an end, an outer surface, a nut hole, a neck (31), a nut thread (32), multiple bars (33) and a holding portion (34). The end of the nut (30) faces the detent ring (20). The nut hole has one end and an inner surface. The neck (31) is formed on the inner surface of the nut hole at the end of the nut hole. The nut thread (32), which is for tightening on the threaded portion (13) of the body (10), is formed on the inner surface of the nut hole. The multiple bars (33) are attached to the end of the nut (30) and engage the at least one detent member (22). The holding portion (34) is polygonal and formed on the outer surface of the nut (30).

The optional annular ring (40) may be attached to the nut (30), is positioned within the nut hole of the nut (30) and mounted around the pipe (50). With reference to FIG. 2, when the connector in accordance with the present invention is tightly tightened, the annular ring (40) is positioned beside the neck (31) of the nut (30).

With reference to FIGS. 1 and 2, the connector in accordance with the present invention is used for connecting two pipes (50) together or one pipe (50) to a device. To use the connector, the user mounts the nut (30) and the annular ring (40) around the pipe (50) before mounting one end of the pipe (50) in the connecting portion (12) of the body (10). Then user may tighten the nut (30) with a hand tool for fastening the nut (30) to the body (10).

With reference to FIG. 5, when the nut (30) is tightened to a certain extent, the bars (33) contact and engage the detent member (22) of the detent ring (20). When a circumferentially moving bar (33) hits the detent member (22), the bar (33) radially presses the detent member (22) toward the recoil chamber (23) and forces the detent member (22) to deform. With reference to FIGS. 3 and 5, when the bar (33) continues to move circumferentially and no longer presses the detent member (22), the detent member (22) restores its original shape and produces a ticking sound to indicate that the nit (30) is sufficiently tightened.

If the ticking sound is ignored, the bars (33) will eventually abuts against the bottom of the annular groove (14) to structurally stop the approaching nut (30). As a result, the nut (30) can not be further tightened, which prevents breaking of the body (10) or the nut (30) itself due to over-tightening.

When compared with the aforementioned conventional connector, the connector in accordance with the present invention provides the following advantages.

1. With reference to FIG. 3, the bars (33) of the nut (30) pushes the detent member (22) of the detent ring (20) radially. The detent member (22), engages the bars (33) and produces ticking sounds without being constantly pressed, maintains elasticity and functionality.

2. The bottom of the annular groove (14) of the body (10) abuts the bars (33) and prevents the user from over-tightening the nut (30). As a result, the body (10) and the nut (30) will not break due to over-tightening. Whereas if the ticking sounds are ignored and the nut (30) is over tightened in a conventional connector, the detent member may be damaged or broken by the bars.

It is apparent that the connector in accordance with the present invention, which comprises the detent ring (20) detachably mounted around the body (10), is able to lower the cost by separately manufacturing individual parts. The connector in accordance with the present invention not only provides an indicating function by producing ticking sounds, but also comprises an improved structure allowing radial engagement of the bars (33) and the detent member (22). The bars (33) abut against the bottom of the annular groove (14) of the body (10) even when the ticking sounds are ignored to effectively stop the nut (30) from being further tightened to prevent destruction of the nut (30) and the body (10). If a user determine to further tighten the nut (30) whose bars (33) are abutting the bottom of the annular groove (14), the bars (33), which are less important for the pipe-connecting function, will break before the nut (30) and the body (10). A connector in accordance with the present invention with broken bars (33), but with an intact nut (30) and an intact body (10) may still be usable. In other words, the aforementioned structure of the connector in accordance with the present invention also protects the nut (30) and body (10) from destructive operation of a negligent user.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A connector comprising
a body comprising
a threaded portion formed on the body comprising
a proximal end;
a detent ring mounted around the body and comprising
a ring body comprising
an outer surface; and
at least one resilient detent member attached to the outer surface of the ring body; and
a nut screwed to the threaded portion of the body and comprising
an end; and
multiple bars attached to the end of the nut and engaging the at least one detent member.

2. The connector as claimed in claim 1, wherein
the detent member deforms when engaging one of the bars of the nut and ticks and restores an original shape when go-off the bar.

3. The connector as claimed in claim 1, further comprising
a recoil chamber formed between the ring body of the detent ring and the detent member.

4. The connector as claimed in claim 2, further comprising
a recoil chamber formed between the ring body of the detent ring and the detent member.

5. The connector as claimed in claim 1, wherein
the detent ring further comprises
a first fastener formed on the ring body; and
a second fastener formed on the ring body for connecting to the first fastener.

6. The connector as claimed in claim 2, wherein
the detent ring further comprises
a first fastener formed on the ring body; and
a second fastener formed on the ring body for connecting to the first fastener.

7. The connector as claimed in claim 4, wherein
the detent ring further comprises
a first fastener formed on the ring body; and
a second fastener formed on the ring body for connecting to the first fastener.

8. The connector as claimed in claim 2, wherein
the body further comprises an annular slot formed beside the proximal end of the threaded portion.

9. The connector as claimed in claim 3, wherein
the body further comprises an annular slot formed beside the proximal end of the threaded portion.

10. The connector as claimed in claim 4, wherein
the body further comprises an annular slot formed beside the proximal end of the threaded portion.

11. The connector as claimed in claim 5, wherein
the body further comprises an annular slot formed beside the proximal end of the threaded portion.

12. The connector as claimed in claim 6, wherein
the body further comprises an annular slot formed beside the proximal end of the threaded portion.

13. The connector as claimed in claim 7, wherein
the body further comprises an annular slot formed beside the proximal end of the threaded portion.

14. The connector as claimed in claim 8, wherein
the body further comprises a positioning member formed in the annular slot; and
the detent ring further comprises a positioning element mounted on the positioning member of the body.

15. The connector as claimed in claim 9, wherein
the body further comprises a positioning member formed in the annular slot; and
the detent ring further comprises a positioning element mounted on the positioning member of the body.

16. The connector as claimed in claim 10, wherein
the body further comprises a positioning member formed in the annular slot; and
the detent ring further comprises a positioning element mounted on the positioning member of the body.

17. The connector as claimed in claim 11, wherein
the body further comprises a positioning member formed in the annular slot; and
the detent ring further comprises a positioning element mounted on the positioning member of the body.

18. The connector as claimed in claim 12, wherein
the body further comprises a positioning member formed in the annular slot; and
the detent ring further comprises a positioning element mounted on the positioning member of the body.

19. The connector as claimed in claim 13, wherein
the body further comprises a positioning member formed in the annular slot; and
the detent ring further comprises a positioning element mounted on the positioning member of the body.
